(19) United States
(12) Patent Application Publication
(10) Pub. No.: US 2006/0033859 A1
(43) Pub. Date: Feb. 16, 2006

(54) Liquid crystal display device

(76) Inventor: Young-Nam Yun, Seoul (KR)

Correspondence Address: CANTOR COLBURN, LLP, 55 GRIFFIN ROAD SOUTH, BLOOMFIELD, CT, 06002, US

(21) Appl. No.: 10/530,231

(22) PCT Filed: Sep. 29, 2003
(86) PCT No.: PCT/KR03/01983

§ 371 Date: Apr. 4, 2005

(30) Foreign Application Priority Data
Oct. 4, 2002 (KR) 10-2002-0060462

(51) Int. Cl. G02F 1/1335

(52) U.S. Cl. 349/64

(57) ABSTRACT

Disclosed is a liquid crystal display device (700) capable of improving a display characteristic and a viewing angle as well as visibility in a reflection mode. A semi-transmissive film (600) is positioned between a light generating section (100) and a liquid crystal display panel (200) in order to partially transmit or reflect light supplied from an exterior. A polarizing plate (400), one surface of which is anti-glare treated, is positioned between the liquid crystal display panel (200) and the semi-transmissive film (600). The polarizing plate (400) diffuses light transmitted through or reflected from the semi-transmissive film. The display characteristic and viewing angle of the liquid crystal display device may be improved and reflectivity of light in the reflection mode may increase, so that visibility is improved.

### TECHNICAL FIELD

The present invention relates to a liquid crystal display device, and more particularly to a liquid crystal display device capable of improving a display characteristic and a viewing angle as well as visibility in a reflection mode.

### BACKGROUND ART

An electronic display device plays an important role in this age of an information-oriented society, and various kinds of electronic display devices are widely used in various industrial fields.

As a semiconductor technique makes great strides, solidification of various electronic devices with low driving voltage, low power consumption, light weight and compact size has been achieved. In this regard, there is required to fabricate a slimmer and lighter flat-panel type display device having low driving voltage and low power consumption adapted for new industrial environment.

Among presently developed display devices, a liquid crystal display device has a slimmer and lighter structure with low power consumption and low driving voltage, so it is widely used in various electronic appliances.

The liquid crystal display device is classified into a transmissive type liquid crystal display device, a reflective type liquid crystal display device and a reflective-transmissive type liquid crystal display device depending on a light source as used. The transmissive type liquid crystal display device displays an image by using a light generating section positioned at a rear portion of a liquid crystal cell and the reflective type liquid crystal display device displays an image by using natural light. In addition, the reflective-transmissive type liquid crystal display device uses a light source accommodated in a display device when displaying an image in a room or in a place where an external light source is not provided (transmissive mode). If external light is sufficiently provided, the reflective-transmissive type liquid crystal display device displays an image by reflecting light incident from the external light source (reflective mode).

The reflective-transmissive liquid crystal display device includes a liquid crystal display panel having a first substrate, a second substrate opposite to the first substrate and a liquid crystal layer interposed between the first and second substrates, and a light generating section positioned at a rear portion of the liquid crystal display panel.

The first substrate includes a transparent electrode and a reflection electrode connected to a thin film transistor (hereinafter, referred to TFT). Light radiated into the first substrate from the light generating section passes through the transparent electrode. The reflection electrode reflects light incident through the second substrate. That is, a transmissive region only exists in the transparent electrode. The other parts of the first substrate act as a reflection region for reflecting light incident through the second substrate.

In addition, the second substrate includes a color filter consisting of RGB pixels, which generate predetermined colors when light passes therethrough, an intercepting layer for preventing light from being leaked between pixels, and a common electrode.

In addition, first and second polarizing plates are attached to outer portions of the first and second substrates, respectively, in order to allow external light to constantly pass through the first and second substrates depending on an aligning direction of the liquid crystal layer. The first and second polarizing plates are arranged, such that polarizing axes thereof are vertically positioned to each other.

A first ¼λ, phase-difference plate is disposed between the first substrate and the first polarizing plate, and a second ¼λ, phase-difference plate is disposed between the second substrate and the second polarizing plate. The first and second ¼λ phase-difference plates change linear polarized light into circular polarized light or vice versa by applying a phase difference of ¼λ to two polarizing components, which are parallel to optical axes of the first and second ¼λ phase-difference plates and vertical to each other.

However, according to the conventional reflective-transmissive type liquid crystal display device, there is required to attach a broadband ¼λ phase-difference plate to the first and second substrate, respectively, to cover the polarizing plate as well as a visible ray area, so manufacturing cost thereof increases as compared with that of the transmissive type liquid crystal display device. In addition, light transmittance of the conventional reflective-transmissive type liquid crystal display device is lower than that of the transmissive type liquid crystal display device in the transmissive mode so the contrast ratio (C/R) thereof will be lowered.

Furthermore, Δnd of the liquid crystal layer in the conventional reflective-transmissive type liquid crystal display device is smaller than and of the liquid crystal layer in the transmissive type liquid crystal display device, so there is required to reduce a gap (d) of the liquid crystal cell and a refractive-index anisotropy (Δn) of liquid crystal. Accordingly, not only is the manufacturing process of the conventional reflective-transmissive type liquid crystal display device difficult, but also the reliability of liquid crystal is lowered.

For this reason, a recently used reflective-transmissive type liquid crystal display device adopts a structure capable of reflecting or transmitting light from an exterior of the liquid panel while using the liquid crystal display panel of the transmissive type liquid crystal display device. That is, the recently used reflective-transmissive type liquid crystal display device includes a semi-transmissive sheet, which allows a part of light incident between the liquid crystal display panel and the light generating section to transmit therethrough and reflects the remaining part of light.

However, the above structure represents inferior visibility and front reflection characteristic in the reflective mode. That is, in the reflective mode, light incident through the first substrate is specularly reflected at the semi-transmissive sheet, so visibility of light is deteriorated and the viewing angle thereof becomes narrow.

### DISCLOSURE OF THE INVENTION

The present invention provides a liquid crystal display device capable of improving a display characteristic and a viewing angle as well as visibility in a reflection mode.

In one aspect of the invention, there is provided a liquid crystal display device comprising: a light generating section to generate first light; a polarizing member disposed on the light generating section so as to generate third light by polarizing and diffusing first light; and a liquid crystal display panel disposed on the polarizing member to display an image by using third light and including a first substrate, a second substrate opposite to the first substrate and liquid crystal interposed between the first and second substrates.

In another aspect, there is provided a liquid crystal display device comprising: a light generating section to generate first light; a semi-transmissive film disposed on the light generating section in order to allow first light to pass therethrough and to partially reflect second light directed in opposition to first light; a polarizing member disposed on the semi-transmissive film so as to generate fifth light by polarizing and diffusing first light and to generate sixth light by polarizing and diffusing second light; and a liquid crystal display panel disposed on the polarizing member to display an image by selectively receiving fifth light or sixth light and including a first substrate, a second substrate opposite to the first substrate and liquid crystal interposed between the first and second substrates.

According to the liquid crystal display device of the present invention, the semi-transmissive film is positioned between the light generating section and the liquid crystal display panel in order to partially transmit or reflect light supplied from an exterior light source. In addition, the polarizing plate, one surface of which is anti-glare treated, is positioned between the liquid crystal display panel and the semi-transmissive film. Thus, the display characteristic and viewing angle of the liquid crystal display device may be improved, and reflectivity of light in the reflection mode may be increased, so that visibility is improved.

### BRIEF DESCRIPTION OF THE DRAWINGS

The above and other advantages of the present invention will become readily apparent by reference to the following detailed description when considered in conjunction with the accompanying drawings wherein:

FIG. 1 is a sectional view showing a transmissive type liquid crystal display device according to one embodiment of the present invention;

FIG. 2 is a sectional view showing a reflective-transmissive type liquid crystal display device according to one embodiment of the present invention;

FIG. 3 is a detailed view of a liquid crystal display panel shown in FIG. 2;

FIG. 4 is a detailed view of a semi-transmissive film shown in FIG. 2;

FIG. 5 is a detailed view of a polarizing member shown in FIG. 2;

FIG. 6 is a sectional view showing a polarizing member used in a reflective-transmissive type liquid crystal display device according to another embodiment of the present invention;

FIGS. 7A and 7B are views for illustrating an operation principle of a reflective mode in a reflective-transmissive type liquid crystal display device shown in FIG. 2; and

FIGS. 8A and 8B are views for illustrating an operation principle of a transmissive mode in a reflective-transmissive type liquid crystal display device shown in FIG. 2.

### BEST MODE FOR CARRYING OUT THE INVENTION

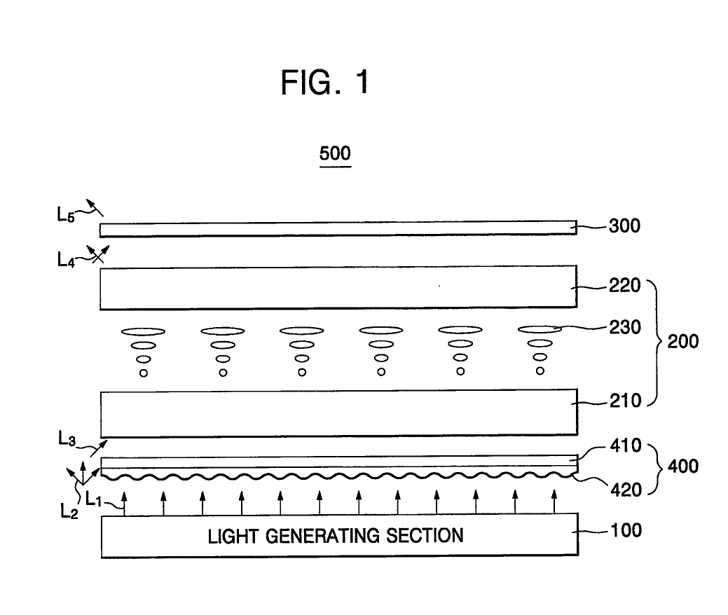

FIG. 1 is a sectional view showing a transmissive type liquid crystal display device 500 according to one embodiment of the present invention.

Referring to FIG. 1, the transmissive type liquid crystal display device 500 of the present invention includes a light generating section 100, a liquid crystal display panel 200, a first polarizing plate 300 and a second polarizing plate 400.

The light generating section 100 generates first light L1. The light generating section 100 is aligned at a rear portion of the liquid crystal display panel 200 in order to radiate first light L1 towards the liquid crystal display panel 200.

The liquid crystal display panel 200 includes a first substrate 210, a second substrate 220 opposite to the first substrate 210 and a liquid crystal layer 230 interposed between the first and second substrates 210 and 220.

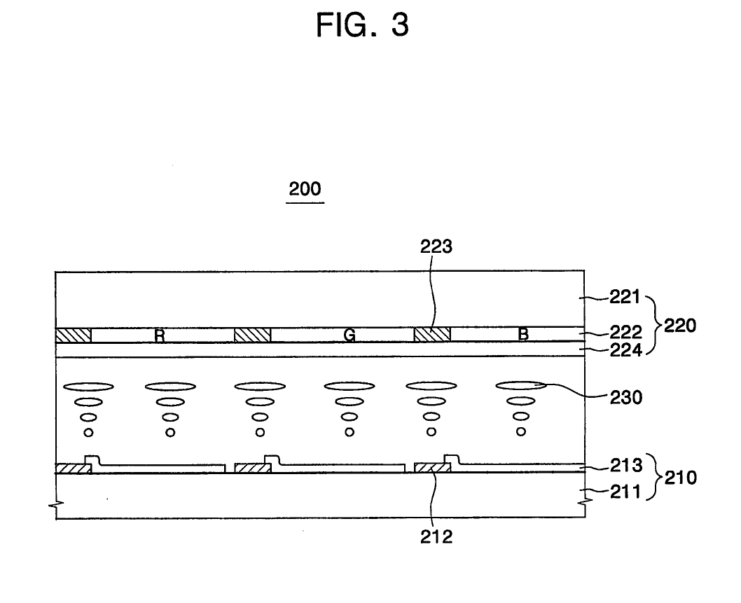

As shown in FIG. 3, the first substrate 210 includes a first glass substrate 211. A TFT 212 that acts a switching device and a transparent electrode 213 comprised of conducive oxide layer, for example, such as indium-tin-oxide (hereinafter, referred to ITO), are formed on the first glass substrate 211. In addition, the second substrate 220 includes a second glass substrate 221. A color filter 222 including RGB color pixels, an intercepting layer 223 for preventing light from being leaked between pixels, and a common electrode 224 comprised of ITO and disposed on the color filter 222 and the intercepting layer 223 are formed on the second glass substrate 221. The first and second substrates 210 and 220 are arranged such that the transparent electrode 213 faces the common electrode 224.

The liquid crystal layer 230 is formed by using twisted nematic (TN) liquid crystal composition, which is twisted at a right angle.

The first and second polarizing plates 300 and 400 allow light to constantly pass through the first and second substrates depending on an aligning direction of the liquid crystal layer 230. In detail, the first polarizing plate 300 opposite to the second substrate 220 is disposed on an upper surface of the liquid crystal display panel 200 and the second polarizing plate 400 opposite to the first substrate 210 is disposed on a lower surface of the liquid crystal display panel 200. The first and second polarizing plates 300 and 400 absorb a part of polarizing components of light and allow remaining polarizing components of light to transmit therethrough, thereby constantly maintaining a transmitting direction of light. The first and second polarizing plates 300 and 400 are arranged such that polarizing axes thereof are vertical to each other.

The second polarizing plate 400 includes a polarizing layer 410 and a light-diffusing layer 420. The light-diffusing layer 420 faces the light generating section 100 and diffuses first light L1 so as to generate second light L2. The polarizing layer 410 is disposed on the light-diffusing layer 420 in opposition to the first substrate 210. The polarizing layer 410 polarizes second light L2 in order to generate third light L3. The light-diffusing layer 420 has a haze value above 20%.

As shown in FIG. 5, the light-diffusing layer 420 includes a coating member 421 coated on one side of the polarizing layer 410 and a scattering member 422 mixed with the coating member 421. The coating member 421 is comprised of acryl-based resin and the scattering member 422 is comprised of silica particles.

Therefore, first light L1 radiated from the light generating section 100 is polarized and diffused by means of the second polarizing plate 400 disposed between the liquid crystal display panel 200 and the light generating section 100 before it is supplied to the liquid crystal display panel 200. That is, the light-diffusing layer 420 of the second polarizing plate 400 diffuses first light L1 so as to generate second light L2, and the polarizing layer 410 polarizes second light L2 in order to generate third light L3.

Then, third light L3 incident into the liquid crystal display panel 200 passes through the liquid crystal layer 230, so that fourth light L4 including image information is generated. Thus, the transmissive type liquid crystal display device 500 is operated. In this case, the viewing angle of the transmissive type liquid crystal display device 500 may be improved.

The second polarizing plate 400 may include the light-diffusing layer 420 opposite to the first substrate 210 and the polarizing layer 410 opposite to the light generating section 100. In this case, first light L1 radiated from the light generating section 100 is polarized through the polarizing layer 410 and diffused by means of the light-diffusing layer 420. The second polarizing plate 400 polarizes first light L1 by using the polarizing layer 410 and diffuses first light L1 by using the light-diffusing layer 420, thereby generating third light L3.

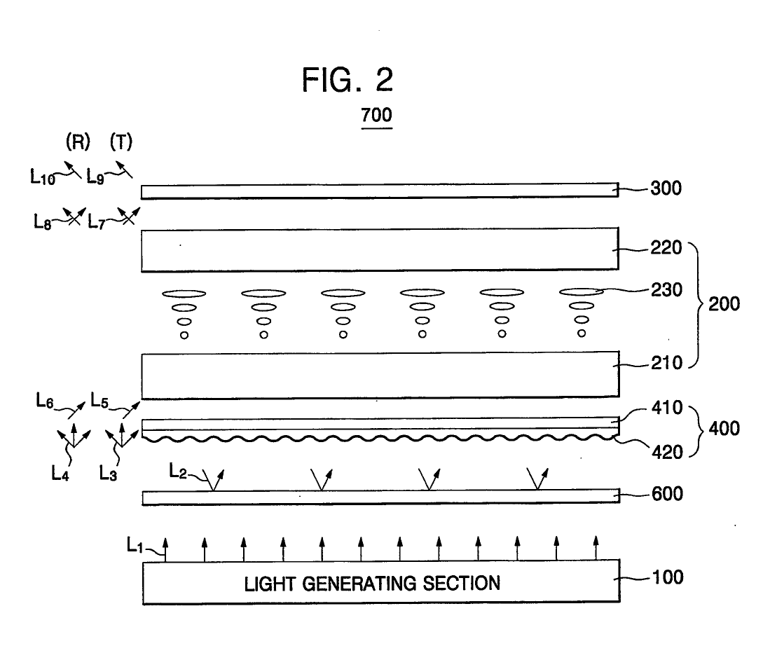

FIG. 2 is a sectional view showing a reflective-transmissive type liquid crystal display device 700 according to another embodiment of the present invention. FIG. 3 is a detailed view of a liquid crystal display panel shown in FIG. 2.

Referring to FIG. 2, the reflective-transmissive type liquid crystal display device 700 includes a light generating section 100, a liquid crystal display panel 200, a semi-transmissive film 600, a first polarizing plate 300 and a second polarizing plate 400.

The light generating section 100 generates first light L1. The light generating section 100 is disposed at a rear portion of the liquid crystal display panel 200 in order to radiate first light L1 towards the liquid crystal display panel 200.

The liquid crystal display panel 200 includes a first substrate 210, a second substrate 220 opposite to the first substrate 210, and a liquid crystal layer 230 interposed between the first and second substrates 210 and 220.

As shown in FIG. 3, the first substrate 210 includes a first glass substrate 211 on which a TFT 212 and a transparent electrode 213 including ITO are formed at an upper surface thereof. The second substrate 220 includes a second glass substrate 221. A color filter 222 including RGB color pixels, an intercepting layer 223 for preventing light from being leaked between pixels, and a common electrode 224 including ITO and disposed on the color filter 222 and the intercepting layer 223 are formed on the second glass substrate 221. The first and second substrates 210 and 220 are arranged such that the transparent electrode 213 faces the common electrode 224.

The liquid crystal layer 230 is formed by using twisted nematic (TN) liquid crystal composition, which is twisted at a right angle.

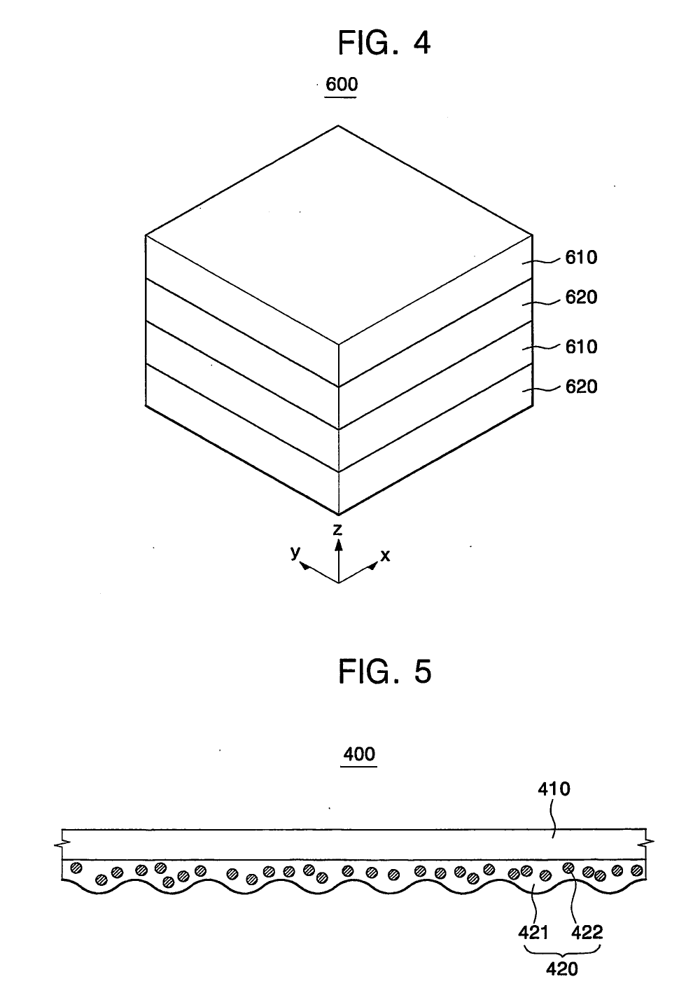

FIG. 4 is a detailed view of the semi-transmissive film 600 shown in FIG. 2.

Referring to FIGS. 2 and 4, the semi-transmissive film 600 is disposed between the light generating section 100 and the liquid crystal display panel 200. The semi-transmissive film 600 includes two transparent films having a refractive index different from each other. That is, a first layer 610 and a second layer 620 are alternately stacked on the semi-transmissive film 600. The semi-transmissive film 600 reflects a part of incident light and allows the remaining of incident light to transmit therethrough.

On the assumption that a vertical direction of the semi-transmissive film 600 is a z-direction and a lateral surface of the semi-transmissive film 600 is an x-y surface, the first layer 610 has a refractive-index anisotropy in the x-y surface thereof, and the second layer 620 has no refractive-index anisotropy in the x-y surface thereof. Accordingly, the semi-transmissive film 600 has an anisotropic characteristic, which represents that transmittance and refractive index of the semi-transmissive film 600 are differently formed depending on the polarizing state and direction of incident light.

If the refractive index of the first and second layers 610 and 620 is same to each other in the x and z-directions and different from each other in the y-direction, when non-polarized light is incident in the vertical direction (z-direction) of the semi-transmissive film 600, polarizing components of the x-direction pass through the semi-transmissive film 600 and polarizing component of the y-direction is reflected from the semi-transmissive film 600 according to Fresnel's equation. An example of a birefringent dielectric multi-layer having the above characteristic is a DBEF (dual brightness enhancement film) available from 3M company.

The DBEF has a multi-layered structure, in which two thin films made of different material are alternately stacked in hundreds of layers. That is, a polyethylene naphthalate layer having a high birefringence and a polymethyl methacrylate (PMMA) layer having an isotropic structure are alternately stacked one upon another, thereby forming the DBEF. Naphthalene radical has a planar structure, so the polyethylene naphthalate layer is easily stacked to each other. The refractive index in the stacking direction of the polyethylene naphthalate layer is remarkably different from the refractive index in the other directions. On the contrary, PMMA, which is amorphous high-polymer, is isotropically aligned so the PMMA layer has the same refractive index in all directions thereof.

As described above, the DBEF of 3M company allows polarizing components of the x-direction to transmit therethrough and reflects polarizing components of the y-direction. The x-direction is parallel to the first polarizing plate 300 and the y-direction is parallel to the second polarizing plate 400.

Referring again to FIG. 2, the first polarizing plate 300 opposite to the second substrate 220 is disposed on an upper surface of the liquid crystal display panel 200, and the second polarizing plate 400 opposite to the first substrate 210 is disposed between the semi-transmissive film 600 and the liquid crystal display panel 200. The first and second polarizing plates 300 and 400 absorb a part of polarizing components of light and allow remaining polarizing components of light to transmit therethrough, thereby constantly maintaining a transmitting direction of light. The first and second polarizing plates 300 and 400 are arranged such that polarizing axes thereof are vertical to each other.

FIG. 5 is a detailed view of the second polarizing plate 400 shown in FIG. 2.

Referring to FIGS. 2 and 5, the second polarizing plate 400 includes a polarizing layer 410 and a light-diffusing layer 420. The light-diffusing layer 420 faces the semi-transmissive film 600. The light-diffusing layer 420 diffuses first light L1 radiated from the light generating section 100 so as to generate third light L3 in the transmissive mode. Also, the light-diffusing layer 420 diffuses second light L2, which is natural light supplied from an exterior, in order to generate fourth light L4 in the reflective mode. The polarizing layer 410 is disposed on the light-diffusing layer 420 in opposition to the first substrate 210. The polarizing layer 410 polarizes third light L3 and fourth light L4 in order to generate fifth light L5 and sixth light L6, respectively. The light-diffusing layer 420 has a haze value above 20%.

The light-diffusing layer 420 is formed through performing an anti-glare (AG) treatment with respect to one surface of the polarizing layer 410. In detail, the light-diffusing layer 420 includes a coating member 421 and a scattering member 422 mixed with the coating member 421. The coating member 421 is comprised of acryl-based resin and the scattering member 422 is comprised of silica particles.

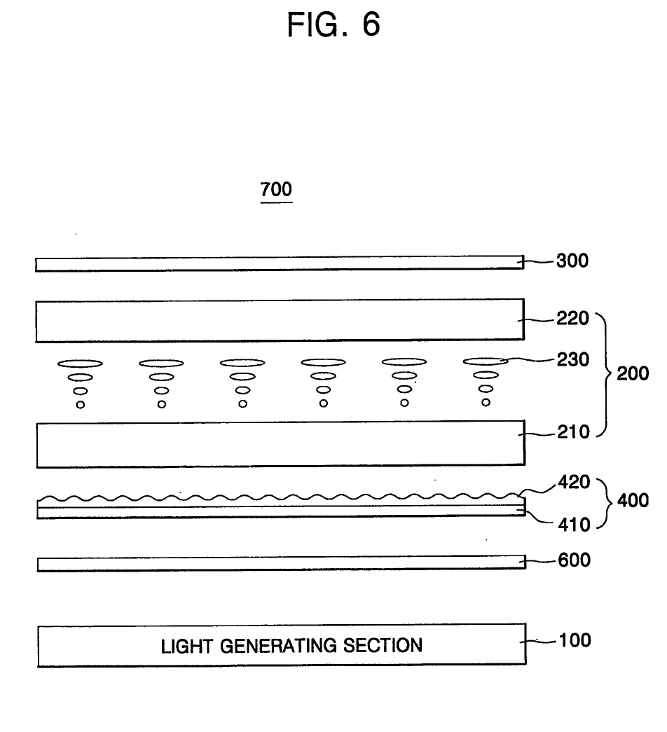

FIG. 6 is a sectional view showing a second polarizing plate 400 used in a reflective-transmissive type liquid crystal display device according to another embodiment of the present invention.

Referring to FIG. 6, the second polarizing plate 400 includes the light-diffusing layer 420 opposite to the first substrate 210 and the polarizing layer 410 opposite to the semi-transmissive film 600. In the transmissive mode, the second polarizing plate 400 polarizes first light L1 radiated from the light generating section 100 by means of the polarizing layer 410 and diffuses first light L1 by means of the light-diffusing layer 420, thereby supplying first light L1 to the liquid crystal display panel 200. In the reflective mode, the second polarizing plate 400 polarizes second light L2 supplied from the exterior by means of the polarizing layer 410 and diffuses second light through the light-diffusing layer 420, thereby supplying second light L2 to the liquid crystal display panel 200.

Referring again to FIG. 2, the reflective-transmissive type liquid crystal display device 700 includes a transmitted light route T and a reflected light route R. The transmitted light route T outputs first light L1 by way of the second polarizing plate 400, the liquid crystal display panel 200 and the first polarizing plate 300 after transmitting first light L, which is forwarded to the first substrate 210 from the light generating section 100, through the semi-transmissive film 600. In addition, the reflected light route R receives second light L2 from the exterior through the first substrate 210 and outputs second light L2 by way of the second polarizing plate 400, the liquid crystal display panel 200 and the first polarizing plate 300 after reflecting second light L2 at the semi-transmissive film 600.

In detail, first light L1 passing through the liquid crystal display panel 200 is partially reflected from the semi-transmissive film 600 in the reflected light route R. First light L1 is polarized and diffused by means of the second polarizing plate 400 disposed between the liquid crystal display panel 200 and the semi-transmissive film 600 before first light L1 is again incident into the liquid crystal display panel 200. That is, the light-diffusing layer 420 of the second polarizing plate 400 diffuses first light L1, which is specularly-reflected from the semi-transmissive film 600 so that it has a narrow viewing angle, thereby generating fourth light L4 having an improved viewing angle. Then, fourth light L4 is incident into the polarizing layer 410 of the second polarizing plate 420. Fourth light L4 is polarized by means of the polarizing layer 410, so that sixth light L6 is generated.

Then, sixth light L6 is incident into the liquid crystal display panel 200 and passes through the liquid crystal layer 230. While passing through the liquid crystal layer 230, the polarizing state of sixth light L6 is varied, so that eighth light L8 is generated. Eighth light L8 is incident into the first polarizing plate 300 and polarized by means of the first polarizing plate 300, thereby generating tenth light L10. Thus, the reflective-transmissive type liquid crystal display device 700 is operated in the reflective mode. The reflective-transmissive type liquid crystal display device 700 may improve reflectivity of light in the reflective mode, thereby improving the visibility and viewing angle of light.

In the transmitted light route T, first light L1 radiated from the light generating section 100 is supplied into the liquid crystal display panel 200 while passing through the semi-transmissive film 600. First light L1 is polarized and diffused by means of the second polarizing plate 400 disposed between the liquid crystal display panel 200 and the semi-transmissive film 600 before it is supplied into the liquid crystal display panel 200. That is, the light-diffusing layer 420 of the second polarizing plate 200 diffuses first light L1, thereby generating third light L3 having an improved viewing angle, and the polarizing layer 410 polarizes third light L3, thereby generating fifth light L5.

Then, fifth light L5 is incident into the liquid crystal display panel 200. The polarizing state of fifth light L5 is varied by means of the liquid crystal display panel 200, so that seventh light L7 is generated. Seventh light L7 is polarized by means of the first polarizing plate 300, so that ninth light L9 is generated. Thus, the reflective-transmissive type liquid crystal display device 700 is operated in the transmissive mode. The reflective-transmissive type liquid crystal display device 700 may improve the viewing angle of light in the transmissive mode.

The light-diffusing layer 420 of the second polarizing plate 400 prevents the Moiré phenomenon, which is created when a pattern of the semi-transmissive film 600 is projected onto a screen of the reflective-transmissive type liquid crystal display device 700.

Hereinafter, an experimental example achieved by using the reflective-transmissive type liquid crystal display device 700 and comparative examples 1 to 3 will be explained to compare the Moiré phenomenon, reflectivity, visibility, and viewing angle thereof with each other.

In the experimental example, the reflective-transmissive type liquid crystal display device 700 includes an anti-glare treated second polarizing plate 400 and a hard-coated first polarizing plate 300. In comparative example 1, hard-coated first and second polarizing plates are used. In comparative example 2, an anti-glare treated first polarizing plate and a hard-coated second polarizing plate are used. In addition, anti-glare treated first and second polarizing plates are used in comparative example 3.

Acryl-based resin mixed with silica particles is coated on the polarizing plate through the anti-glare treatment, and acryl-based resin is coated on the polarizing plate through the hard-coating process.

TABLE 1

| | 1^{st} | | 2^{nd} | | | | | |
|---|---|---|---|---|---|---|---|---|
| | polarizing | | polarizing | | | | Visibility | Visibility |
| | plate | | plate | | Moiré | Reflectivity | (reflective | (transmissive |
| | HC | AG | HC | AG | phenomenon | (%) | mode) | mode) |
| Comparative | ◯ | | ◯ | | Strong | 1.12 | Normal | Superior |
| example 1 | | | | | | | | |
| Comparative | | ◯ | ◯ | | Weak | 2.55 | Inferior | Superior |
| example 2 | | | | | | | | |
| Comparative | | ◯ | | ◯ | None | 2.54 | Inferior | Superior |
| example 3 | | | | | | | | |
| Experimental | ◯ | | | ◯ | None | 1.32 | Superior | Superior |
| example | | | | | | | | |

As shown in table 1, comparative example 1, in which the first and second polarizing plates are subject to hard-coating process without being subject to the anti-glare treatment, represents superior visibility in the transmissive mode. However, the Moiré phenomenon is strongly represented in comparative example 1 as compared with those of the experimental example and comparative examples 2 and 3, in which one of the first and second polarizing plates is anti-glare treated. In addition, reflectivity of comparative example 1 is lower than those of the experimental example and comparative examples 2 and 3, so normal visibility is represented in the reflective mode.

Comparative example 2, in which the first polarizing plate is subject to the anti-glare treatment and the second polarizing plate is subject to the hard-coating process, represents the Moiré phenomenon weaker than that of comparative example 1 and superior visibility in the transmissive mode. In addition, comparative example 2 represents reflectivity higher than that of comparative example 1. However, although reflectivity of comparative example 2 is higher than that of comparative example 1, reflectivity of comparative example 2 is derived from light reflected from the first polarizing plate, which includes light reflected before it passes through the liquid crystal layer. Accordingly, although reflectivity of comparative example 2 is higher than those of comparative example 1 and the experimental example, comparative example 2 represents inferior visibility in the reflective mode.

Comparative example 3, in which the first and second polarizing plates are subject to the anti-glare treatment, does not create the Moiré phenomenon, with representing superior visibility in the transmissive mode. Comparative example 3 represents reflectivity higher than that of comparative example 1. However, as the same as comparative example 2, reflectivity of comparative example 3 is derived from light reflected from the first polarizing plate, which includes light reflected before it passes through the liquid crystal layer. Accordingly, although reflectivity of comparative example 3 is higher than those of comparative example 1 and the experimental example, comparative example 3 represents inferior visibility in the reflective mode.

The experimental example, in which the first polarizing plate is subject to the hard-coating process and the second polarizing plate is anti-glare treated, does not create the Moiré phenomenon with representing superior visibility in the transmissive mode. In addition, the experimental example represents reflectivity higher than that of comparative example 1 and lower than those of comparative examples 2 and 3. However, reflectivity of the experimental example is derived from light, which has transmitted through the liquid crystal layer thereby obtaining image information, so the experimental example represents superior visibility in the reflective mode as compared with visibility of comparative examples 2 and 3. Reflectivity of the experimental example increases as compared with reflectivity of comparative example 1 about 18%, so the experimental example represents visibility superior than that of the comparative example 1 in the reflective mode.

Hereinafter, an operation principle of the reflective-transmissive type liquid crystal display device 700 in the reflective mode and the transmissive mode will be explained.

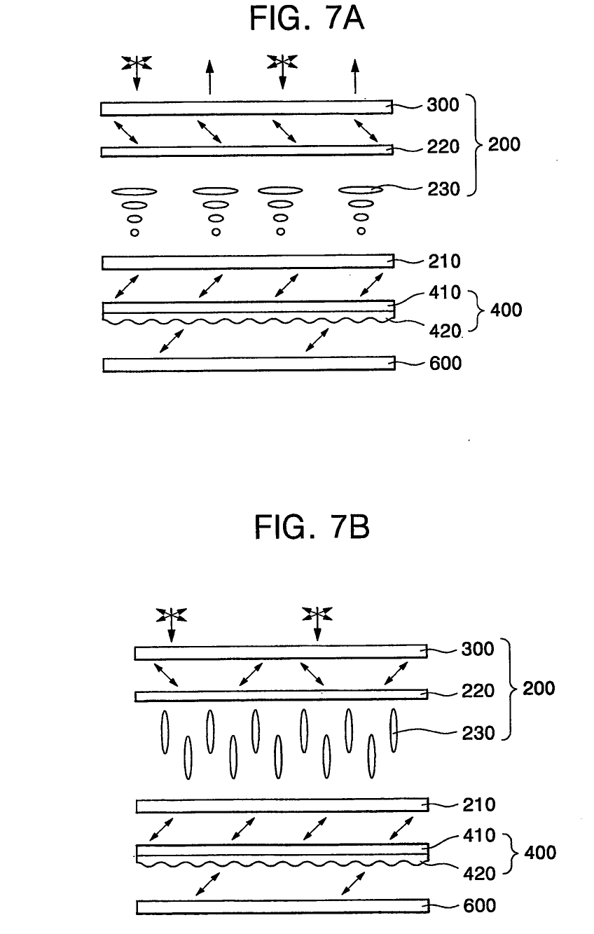

FIGS. 7A and 7B are views for illustrating the operation principle of the reflective mode in the reflective-transmissive type liquid crystal display device.

Referring to FIG. 7A, when pixel voltage is applied to the liquid crystal layer in the reflective mode, light supplied from the exterior is linearly polarized in parallel to a polarizing axis thereof by passing through the first polarizing plate 300. Linearly polarized light passes through the liquid crystal layer 230 and the transparent electrode 213 so that light is again linearly polarized in a direction vertical to the polarizing axis of the first polarizing plate 300 and is incident into the semi-transmissive film 600. The polarizing axis of the first polarizing plate 300 is vertical to the polarizing axis of the second polarizing plate 400, so light incident into the second polarizing plate 400 is parallel to the polarizing axis of the second polarizing plate 400. Accordingly, a part of light, which is linearly polarized in parallel to the polarizing axis of the second polarizing plate 400 passes through the semi-transmissive film 600 and the remaining part of light is reflected from the semi-transmissive film 600.

Linearly polarized light, which is specularly-reflected from the semi-transmissive film 600, is diffused by means of the light-diffusing layer 420 of the second polarizing plate 400 and linearly polarized by means of the polarizing layer 410, so that light having improved viewing angle is outputted. In addition, diffused and linearly polarized light passes through the transparent electrode and the liquid crystal layer 230. Since the liquid crystal layer 230 is aligned depending on pixel voltage applied thereto, the polarizing state of diffused and linearly polarized light is varied while passing through the liquid crystal layer 230. Therefore, light is linearly polarized in a direction parallel to the polarizing axis of the first polarizing plate 230, and then passes through the first polarizing plate 300, thereby displaying a white image.

As shown in FIG. 7B, when pixel voltage is not applied to the liquid crystal layer in the reflective mode, light supplied from the exterior passes through the first polarizing plate 300 and is linearly polarized in a direction parallel to the polarizing axis of the first polarizing plate 300. Since pixel voltage is not applied to the liquid crystal layer 230, linearly polarized light passes through the liquid crystal layer 230 without varying the polarizing state of linearly polarized light and is incident into the semi-transmissive film 600. Linearly polarized light is selectively reflected from the semi-transmissive film 600 or passes through the semi-transmissive film 600 so that light is supplied into the second polarizing plate 400. Light incident into the second polarizing plate 400 has a direction vertical to the polarizing axis of the second polarizing plate 400, so it is absorbed in the second polarizing plate 400.

Therefore, light is not reflected from the semi-transmissive film 600, so a black image is displayed.

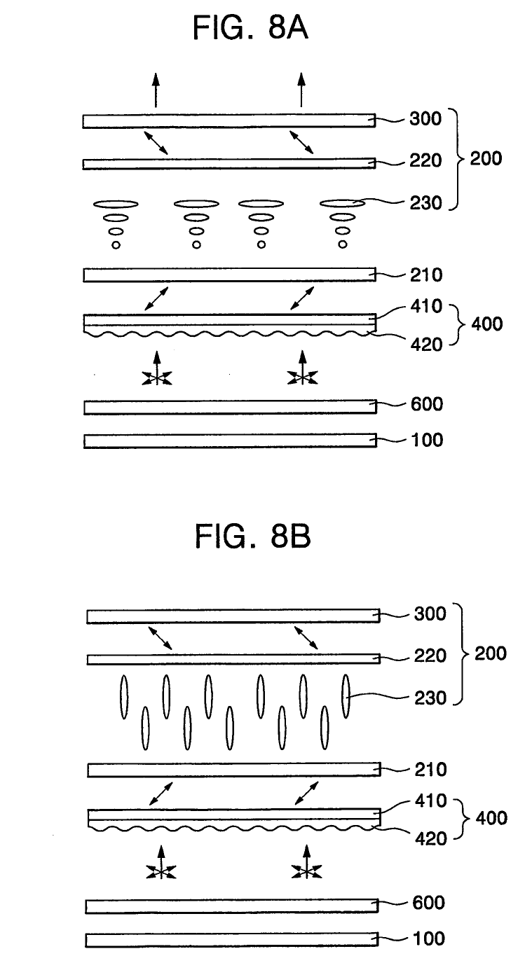

FIGS. 8A and 8B are views for illustrating the operation principle of the transmissive mode in the reflective-transmissive type liquid crystal display device.

Referring to FIG. 8A, when pixel voltage is applied to the liquid crystal layer in the transmissive mode, light supplied from the light generating section 100 is incident into the semi-transmissive film 600. The semi-transmissive film 600 allows polarizing components parallel to the x-axis direction, which are included in light parallel to the polarizing axis of the second polarizing plate 400, to be partially reflected therefrom or to partially pass therethrough, and reflects polarizing components, which are parallel to the y-axis direction.

Light passing through the second polarizing plate 400 by way of the semi-transmissive film 600, is diffused by means of the diffusing layer 420 of the second polarizing plate 400 so that the viewing angle of light is improved. Then, light is linearly polarized in a direction parallel to the polarizing axis of the second polarizing plate 400 by means of the polarizing layer. That is, light is linearly polarized in a direction vertical to the polarizing axis of the first polarizing plate 300. Then, diffused and linearly polarized light passes through the transparent electrode 213 and the liquid crystal layer 230, so that light is again linearly polarized in a direction parallel to the polarizing axis of the first polarizing plate 300. Since the liquid crystal layer 230 is aligned in a predetermined pattern due to pixel voltage applied thereto, the polarizing state of diffused and linearly polarized light is adjusted by means of the liquid crystal layer 230.

Accordingly, light polarized in parallel to the polarizing axis of the first polarizing plate 300 by means of the liquid crystal layer 230 passes through the first polarizing plate 300, thereby displaying a white image.

As shown in FIG. 8B, when maximum pixel voltage is not applied to the liquid crystal layer in the transmissive mode, light radiated from the light generating section 100 is incident into the semi-transmissive film 600. The semi-transmissive film 600 allows a part of light to pass therethrough and reflects a remaining part of light Light passing through the second polarizing plate 400 by way of the semi-transmissive film 600 is diffused by means of light-diffusing layer 420, so that the viewing angle of light is improved. Then, light is linearly polarized in a direction parallel to the polarizing axis of the second polarizing plate 400 by means of the polarizing layer 410. That is, light is linearly polarized in a direction vertical to the polarizing axis of the first polarizing plate 300. Then, linearly polarized light having the improved viewing angle passes through the transparent electrode 213 and the liquid crystal layer 230 without varying the polarizing state thereof.

Therefore, light, which is linearly polarized in the direction vertical to the polarizing axis of the first polarizing plate 300 does not pass through the first polarizing plate 300, so a black image is displayed.

According to the liquid crystal display device of the present invention, the semi-transmissive film is positioned between the light generating section and the liquid crystal display panel in order to partially transmit or reflect light supplied from the exterior. In addition, the polarizing plate, one surface of which is subject to the anti-glare treatment, is positioned between the liquid crystal display panel and the semi-transmissive film.

Therefore, the viewing angle of the liquid crystal display device may be improved and reflectivity of light may be increased in the reflective mode, thereby improving visibility. In addition, the present invention may prevent the Moiré phenomenon, which is caused when a pattern of the semi-transmissive film is projected onto a screen of the reflective-transmissive type liquid crystal display device.

While the present invention has been described in detail with reference to the preferred embodiments thereof, it should be understood to those skilled in the art that various changes, substitutions and alterations can be made hereto without departing from the scope of the invention as defined by the appended claims.

1. A liquid crystal display device comprising:
a light generating section to generate first light;
a polarizing member disposed on the light generating section so as to generate third light by polarizing and diffusing first light; and
a liquid crystal display panel disposed on the polarizing member to display an image by using third light and including a first substrate, a second substrate opposite to the first substrate and liquid crystal interposed between the first and second substrates.

2. The liquid crystal display device as claimed in claim 1, wherein the polarizing member comprises:
a light-diffusing layer positioned in opposition to the light generating section so as to generate second light by diffusing first light; and
a polarizing layer disposed on the light-diffusing layer so as to generate third light by polarizing second light.

3. The liquid crystal display device as claimed in claim 1, wherein the polarizing member comprises:
a polarizing layer positioned in opposition to the light generating section so as to generate second light by polarizing first light; and
a light-diffusing layer disposed on the polarizing layer so as to generate third light by diffusing second light.

4. A liquid crystal display device comprising:
a light generating section to generate first light;
a semi-transmissive film disposed on the light generating section in order to allow first light to pass therethrough and to partially reflect second light directed in opposition to first light;
a polarizing member disposed on the semi-transmissive film so as to generate fifth light by polarizing and diffusing first light and to generate sixth light by polarizing and diffusing second light; and
a liquid crystal display panel disposed on the polarizing member to display an image by selectively receiving fifth light or sixth light and including a first substrate, a second substrate opposite to the first substrate and liquid crystal interposed between the first and second substrates.

5. The liquid crystal display device as claimed in claim 4, wherein the polarizing member comprises:
a light-diffusing layer positioned in opposition to the semi-transmissive film so as to generate third light by diffusing first light and to generate fourth light by diffusing second light; and
a polarizing layer disposed on the light-diffusing layer so as to generate fifth light by polarizing third light and to generate sixth light by polarizing fourth light.

6. The liquid crystal display device as claimed in claim 5, wherein the light-diffusing layer has a haze value above 20%.

7. The liquid crystal display device as claimed in claim 5, wherein the light-diffusing layer comprises coating material coated on one surface of the polarizing layer and scattering material mixed with coating material.

8. The liquid crystal display device as claimed in claim 7, wherein coating material comprises acryl-based resin and scattering material includes silica particles.

9. The liquid crystal display device as claimed in claim 4, wherein the polarizing member comprises:
a polarizing layer positioned in opposition to the semi-transmissive film so as to generate third light by polarizing first light and to generate fourth light by polarizing second light; and
a light-diffusing layer disposed on the polarizing layer in opposition to the first substrate so as to generate fifth light by diffusing third light and to generate sixth light by diffusing second light.

10. The liquid crystal display device as claimed in claim 4, wherein the second substrate comprises a color filter and a first electrode and the first substrate comprises a switching device and a second electrode opposite to the first electrode.
